(19) United States
(12) Patent Application Publication
(10) Pub. No.: US 2006/0265718 A1
(43) Pub. Date: Nov. 23, 2006

(54) Injection-based simulation for button automation on button-aware computing platforms

(75) Inventors: Michael H. Tsang, Bellevue, WA (US); Robert J. Jarrett, Snohomish, WA (US); Sumit Mehrotra, Bellevue, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/133,231

(22) Filed: May 20, 2005

(51) Int. Cl. G06F 9/46; G06F 3/00

(52) U.S. Cl. 719/321; 715/700

(57) ABSTRACT

A methodology for simulating the pressing and releasing of hardware buttons on a computing device is described. Actual hardware button signals are injected at a low level in a system stack, and the data resulting from those signals propagates naturally through the system and are processed and formatted in the layers of the system stack in a normal manner, eventually being directed to the target software application being tested as an action for that software application associated with the button activity. In this end-to-end approach, button events are simulated by injecting data into the system from the bottom-most layers where raw data may be, e.g., simply the state of the button. Thus, this would be independent of the actual implementation of converting button events to actions. Such simulation helps developers and test teams run real-life tests and scenarios in a reproducible and efficient manner, irrespective of the hardware platform.

### FIELD OF THE INVENTION

Aspects of the present invention are directed to simulation and automation of button activation and deactivation on button-aware computing platforms.

### BACKGROUND OF THE INVENTION

The use of hardware buttons has enhanced the usefulness and flexibility of computing devices such as handheld computers, tablet-style computers, and the like. Typically, such smaller computing devices have main user input resources that are not button-based. For example, for many such computing devices, the main way for a user to interact with the computing device is to use a stylus-based interface on a touch-sensitive display. Hardware buttons may also be provided as a secondary mode of input. The user may press and/or release buttons, and the underlying platform converts the button activity into actions.

There is a need for testing of the software applications and operating systems that are button-aware, that is, that respond to button activity on such computing devices. However, efficient testing of such a button-based platform is challenging because button pressing is a manual process. For instance, to quickly perform such testing by actually pressing buttons, an army of robots would literally be required. This is expensive and unrealistic, and so the physical pressing of buttons has become time-consuming and error-prone using alternative methods. The difficulties with such testing are multiplied where there are various different hardware platforms to be tested with the same target software. Different hardware platforms may have different buttons that are provided in different locations and/or in different quantities. Thus, a customized testing scenario must be created for each different hardware platform. This, again, becomes unwieldy, inefficient, error-prone, and expensive.

There have been various efforts to improve upon the testing process, but such efforts have not resulted in a satisfactory solution. One way is to provide a stick-like instrument mounted on an electro-mechanical device and control it to mimic user actions. However, this is neither a cheap nor realistic methodology. Another approach is to simulate button events by providing automation hooks in various layers of the operating system stack where the button input is massaged into an expected format. However, this is difficult at best and is again dependent upon the implementation of the system being tested. Thus, a customized testing scenario would still need to be created for each new platform to be tested.

A better way to simulate hardware button events is therefore needed.

### SUMMARY OF THE INVENTION

Aspects of the present invention are directed to simulating the actual hardware button signals at a low level. The data resulting from those signals then propagates naturally through the system, being processed and formatted in the layers of the system stack in a normal manner, eventually being directed to the target software application being tested as an action for that software application associated with the button activity. In this end-to-end approach, button events are simulated by injecting data into the system from the bottom-most layers where raw data may be the basic property of the button, e.g., the state of the button (e.g., pressed or released). Thus, this would be independent of the actual implementation of converting button events to actions. Such simulation helps developers and test teams run real-life tests and scenarios in a reproducible and efficient manner, irrespective of the hardware platform.

Further aspects of the invention are directed to mapping actions to buttons, button events, and/or the physical orientation of the computing device being tested. Such mapping may be set or read by a testing software application using an application programming interface (API). Because the mapping may be dynamically set and changed during the testing process, this allows platforms having only a single hardware button (or a small number of hardware buttons) to be tested under a variety of configurations.

Still further aspects of the present invention are directed to providing a create-once-use-many-times methodology for testing. This is because a uniform platform for button testing is provided that may be used with a variety of hardware platforms and target software. The result is that testing time and expense is substantially reduced while repeatability is increased. The testing platform is allowed to be uniformly applicable due to the fact that an injected button event, just as the actual pressing of a hardware button, causes data to be injected at a low level. Because the injected data must propagate throughout the normal system, such testing exercises the whole system, as opposed to providing automation hooks at custom-selected locations and artificially providing data to the system at a particular layer in the particular format required.

Using the described testing methodology, testing teams may rapidly automate and cover key scenarios in their tests. Time is therefore saved by automating the onerous task of repeating the same button actions on different hardware platforms and under different conditions.

These and other aspects of the invention will be apparent upon consideration of the following detailed description of illustrative embodiments.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a functional block diagram of an illustrative computer that may be used to implement various aspects of the present invention.

FIG. 2 is a plan view of an illustrative tablet-style computer that may be used in conjunction with aspects of the present invention.

FIG. 3 is a functional block diagram of an illustrative operating system, driver, and software application functions that are relevant to aspects of the present invention.

FIG. 4 is a flowchart showing illustrative steps that may be taken to simulate one or more button events.

FIGS. 5 and 6 show illustrative data that may be received by the a virtual button driver in accordance with aspects of the present invention.

### DETAILED DESCRIPTION OF ILLUSTRATIVE EMBODIMENTS

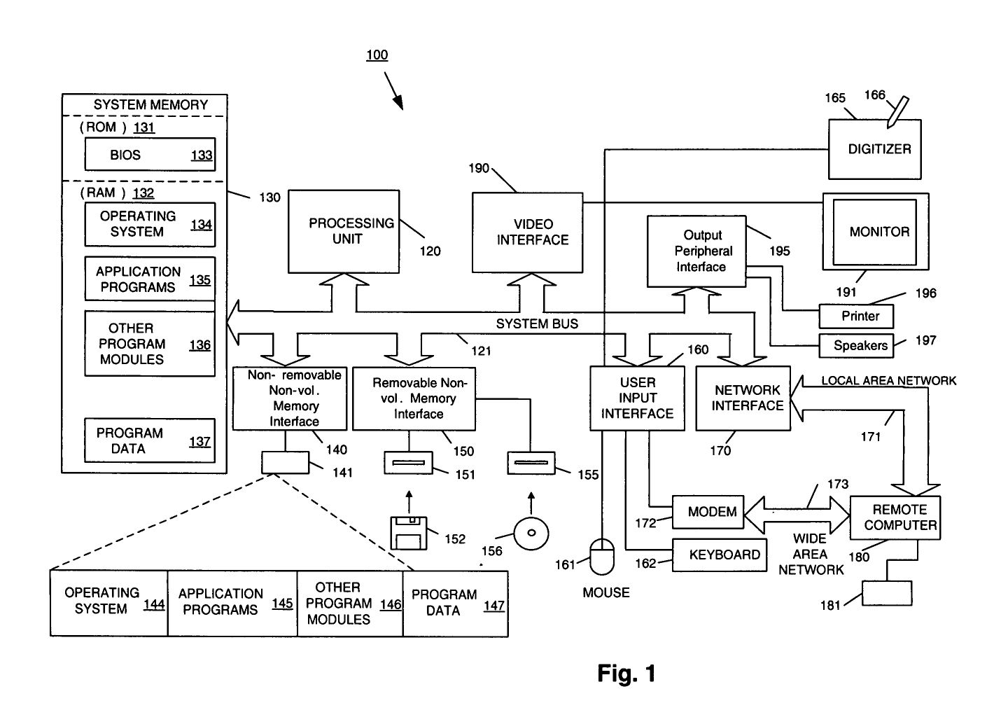

FIG. 1 illustrates an example of a suitable computing system environment 100 in which aspects of the invention may be implemented. Computing system environment 100 is only one example of a suitable computing environment and is not intended to suggest any limitation as to the scope of use or functionality of the invention. Neither should computing system environment 100 be interpreted as having any dependency or requirement relating to any one or combination of components illustrated in illustrative computing system environment 100.

The invention is operational with numerous other general purpose or special purpose computing system environments or configurations. Examples of well known computing systems, environments, and/or configurations that may be suitable for use with the invention include, but are not limited to, personal computers (PCs); server computers; hand-held and other portable devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. The invention may also be operational with distributed computing environments where tasks are performed by remote processing devices that are linked through a communications network. In a distributed computing environment, program modules may be located in both local and remote computer storage media including memory storage devices.

With reference to FIG. 1, illustrative computing system environment 100 includes a general purpose computing device in the form of a computer 100. Components of computer 100 may include, but are not limited to, a processing unit 120, a system memory 130, and a system bus 121 that couples various system components including system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 100 typically includes a variety of computer-readable media. Computer readable media can be any available media that can be accessed by computer 100 such as volatile, nonvolatile, removable, and non-removable media. By way of example, and not limitation, computer-readable media may include computer storage media and communication media. Computer storage media may include volatile, nonvolatile, removable, and non-removable media implemented in any method or technology for storage of information such as computer-readable instructions, data structures, program modules or other data. Computer storage media includes, but is not limited to, random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium that can be used to store the desired information and which can accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF) (e.g., BLUETOOTH, WiFi, UWB), optical (e.g., infrared) and other wireless media. Any single computer-readable medium, as well as any combination of multiple computer-readable media, are both intended to be included within the scope of the term “a computer-readable medium” as used in both this specification and the claims. For example, a computer readable medium includes a single optical disk, or a collection of optical disks, or an optical disk and a memory.

System memory 130 includes computer storage media in the form of volatile and/or nonvolatile memory such as ROM 131 and RAM 132. A basic input/output system (BIOS) 133, containing the basic routines that help to transfer information between elements within computer 100, such as during start-up, is typically stored in ROM 131. RAM 132 typically contains data and/or program modules that are immediately accessible to and/or presently being operated on by processing unit 120. By way of example, and not limitation, FIG. 1 illustrates software in the form of computer-executable instructions, including operating system 134, application programs 135, other program modules 136, and program data 137.

Computer 100 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. Hard disk drive 141 is typically connected to system bus 121 through a non-removable memory interface such as an interface 140, and magnetic disk drive 151 and optical disk drive 155 are typically connected to system bus 121 by a removable memory interface, such as an interface 150.

The drives and their associated computer storage media discussed above and illustrated in FIG. 1 provide storage of computer-readable instructions, data structures, program modules and other data for computer 100. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are assigned different reference numbers in FIG. 1 to illustrate that they may be different copies. A user may enter commands and information into computer 100 through input devices such as a keyboard 162 and a pointing device 161, commonly referred to as a mouse, trackball or touch pad. Such pointing devices may provide pressure information, providing not only a location of input, but also the pressure exerted while clicking or touching the device. Other input devices (not shown) may include a microphone, joystick, game pad, satellite dish, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 191 or other type of display device is also coupled to system bus 121 via an interface, such as a video interface 190. Video interface 190 may have advanced 2D or 3D graphics capabilities in addition to its own specialized processor and memory.

Computer 100 may also include a touch-sensitive device 165, such as a digitizer, to allow a user to provide input using a stylus 166. Touch-sensitive device 165 may either be integrated into monitor 191 or another display device, or be part of a separate device, such as a digitizer pad. Computer 100 may also include other peripheral output devices such as speakers 197 and a printer 196, which may be connected through an output peripheral interface 195.

Computer 100 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 100, although only a memory storage device 181 has been illustrated in FIG. 1. The logical connections depicted in FIG. 1 include a local area network (LAN) 171 and a wide area network (WAN) 173, but may also or alternatively include other networks, such as the Internet. Such networking environments are commonplace in homes, offices, enterprise-wide computer networks, intranets and the Internet.

When used in a LAN networking environment, computer 100 is coupled to LAN 171 through a network interface or adapter 170. When used in a WAN networking environment, computer 100 may include a modem 172 or another device for establishing communications over WAN 173, such as the Internet. Modem 172, which may be internal or external, may be connected to system bus 121 via user input interface 160 or another appropriate mechanism. In a networked environment, program modules depicted relative to computer 100, or portions thereof, may be stored remotely such as in remote storage device 181. By way of example, and not limitation, FIG. 1 illustrates remote application programs 182 as residing on memory device 181. It will be appreciated that the network connections shown are illustrative, and other means of establishing a communications link between the computers may be used.

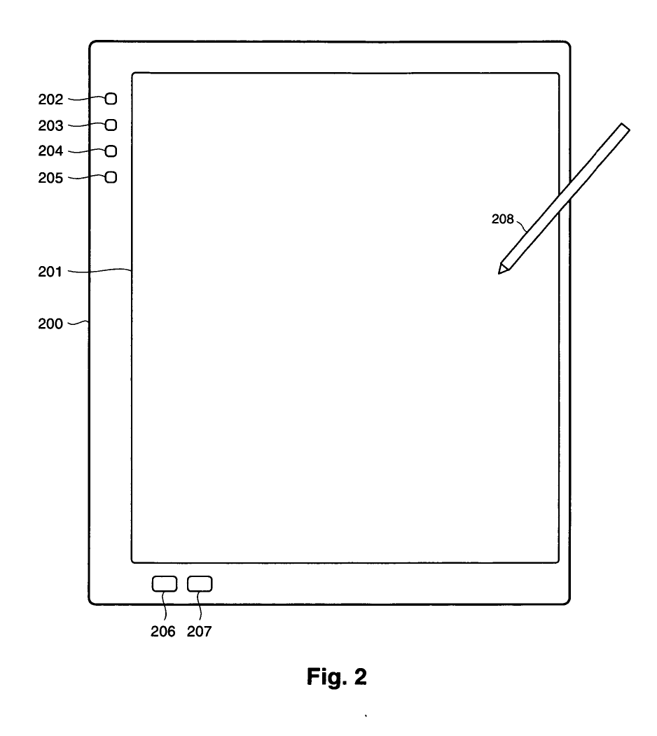

As previously stated, computer 100 may take any of a variety of forms. For example, referring to FIG. 2, computer 100 may take the form of a tablet-style computer 200. Alternatively, computer 100 may take the form of a desktop computer, a laptop computer, a cellular telephone, a personal digital assistance (PDA), a smart phone, a digital camera, a handheld computer, or any other portable or non-portable computing device. In the present example, tablet style computer 200 has a plurality of physical hardware buttons 202-207 that are accessible to, and that may be activated by, a user. Buttons 202-207 are shown as being on the front face of computer 200, however they may be located anywhere that is accessible to the user. For example, one or more of the buttons may be located on the sides or rear of computer 200. In addition, although six buttons are shown in this example, computer 200 may have any number of buttons, or even only a single button. Computer 100 also has a touch-sensitive display 201 on which the user may write and/or otherwise interact using a stylus 208. Stylus 208 may one or more buttons located thereon that are separate from buttons 202-207.

Typically, the pressing and/or releasing of one of buttons 202-207 causes a signal to be sent to a driver running on computer 200. The signal may be data that identifies the particular button pressed or released, as well as an event currently associated with the button (e.g., whether the button has been pressed or released). The driver receives the signal, interprets the signal, and forwards information about which button was pressed or released to the operating system and/or to a software application. The driver may operate at the Human Interface Device (HID) layer and operate in accordance with the HID specification. The HID specification is a well-known standard that may be used for a variety of input devices. The HID specification is mainly implemented in devices connected to a computer via USB but can support input devices that use other types of ports or buses. For example, input devices connected using the IEEE 1394 protocol may be used in accordance with the HID specification.

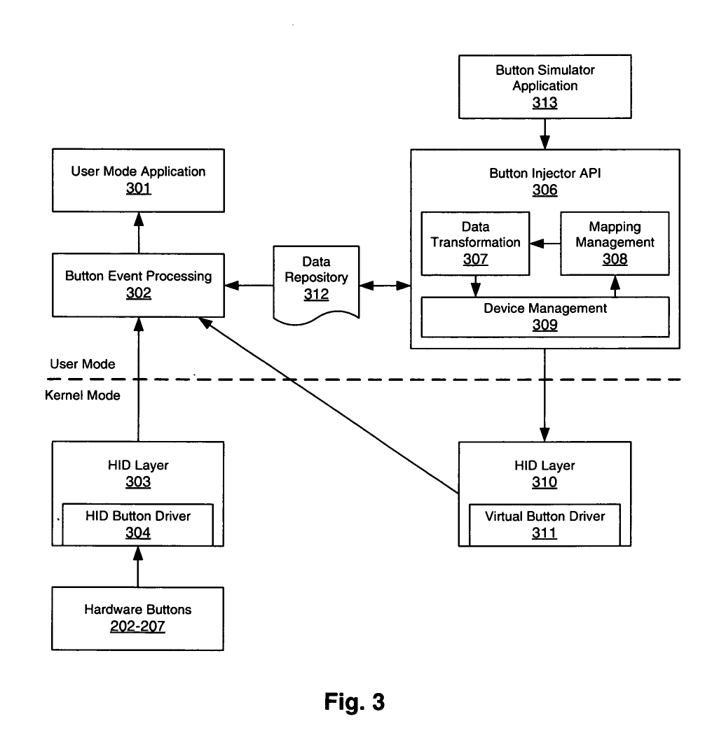

Referring to FIG. 3, a functional block diagram is presented illustrating how various operating system, driver, and software application functions may work together. Many operating systems traditionally provide two “modes”: a user mode and a kernel mode. The user mode is the mode in which most software applications operate. The kernel mode is the mode in which more core process of the operating system itself operate. The kernel is a protected mode of the operating system. In general, software applications must send any process requests via the protected kernel mode.

In the shown embodiment, the following functions are shown. In the kernel mode, an HID layer 303, 310 is provided that implements the HID protocols and communicates with physical input devices such as buttons 202-207. A button driver 304 is provided in HID layer 303 that receives signals from buttons 202-207. Button driver 304 translates these signals into a format that is understandable by a button event processing unit 302, which is in the user mode. Button event processing unit 302 receives this information and passes it on (possibly re-translating the information in the process) to a software application 301 that is interested in knowing the states of one or more of the buttons 202 207. In addition, as will be discussed further below, button event processing unit 302 determines an appropriate action that should be taken depending upon the button, a button event associated with that button, and/or a current physical orientation of the computing device.

In addition, another driver, called herein a virtual button driver 311, is provided in the HID layer of the kernel mode. Virtual button driver 311 receives information from another software application, called herein button simulator software application 313, via a programming interface such as application programming interface (API) 306, called herein button injector API 306. Button injector API 306 provides various functionality to software application 313 including mapping of buttons to actions and communication with virtual button driver 311. Although software application 313 is shown in FIG. 3 as being separate from software application 301, they may be the same software application.

Button injector API 306 may provide a variety of functionality that is available to software application 313. Mapping is one functionality, in which software application 301 (or the operating system) may get or set the mapping of one or more buttons to one or more actions and/or read the currently set mapping. For example, using commands and/or queries defined by button injector API 306, software application 313 (or the operating system) may be able to define which out of a plurality of actions are to be mapped to each of buttons 202-207 (or a subset thereof). The mappings of buttons, button events, physical orientations, and actions may be stored in a data repository 312, such as an operating system registry. An action may be any action, such as opening a software application, issuing a command, shutting down computer 200, sending a page up or down request, pressing a function key, or performing any other function. In this way, each of buttons 202-207 may be mapped, or associated with, different actions. Using button injector API 306, software application 313 (or the operating system) may map only a particular one of the buttons, a particular subset of the buttons, or all of the buttons, to one or more actions. This means that upon performing a particular event associated with a button (e.g., upon pressing the button), the action associated with the button would be performed.

The particular action to be performed may depend not only on which button is pressed, but also which event is performed on the button. There are many possible events that may be performed on a button. Such events are also referred to herein as button events. For instance, a button press event is where a button is pressed. A button release event is where a button is released. A button hold event is where a button is pressed for at least a threshold period of time. A button click event is where a button is pressed for only a short period of time. The button hold and click events may be considered separate events in and of themselves, or they may be considered particular combinations of the basic button press and button release events. Table 1 below shows an example of how various actions may be associated with some of the buttons of FIG. 2 and with button events, wherein each button may be assigned a unique button identifier, or button ID.

TABLE 1

| button | | button double-click | |
|---|---|---|---|
| ID | button press event | event | button hold event |
| 1 | action 1 | action 2 | action 1 |
| 2 | action 3 | action 3 | action 4 |
| 3 | action 5 | action 6 | action 7 |

Button 202, for example, may be assigned button ID 1; button 203 may be assigned button ID 2; and button 203 may be assigned button ID 3. According to Table 1, for instance, pressing button 202 (button ID 1) would result in action 1 occurring, double-clicking button 202 would result in action 2 occurring, and holding down button 202 would result in action 1 occurring (the same as where button 202 is merely pressed).

In addition, the mapping of actions with buttons and events may further take into account the physical orientation of computer 200. This may be especially useful where, as in the present example, computer 200 is a portable computing device that may operate in different modes depending upon its physical orientation. For instance, computer 200 may have an orientation sensor that detects the physical orientation of computer 200 (e.g., vertical, rotated sideways, or at some angle in between) and operate in a particular mode depending upon the orientation. Such sensors are well known. If computer 200 is oriented vertically (such as shown in FIG. 2), then, for example, display 201 may display the user interface in a portrait (i.e., vertical) configuration. But, if computer 200 is oriented horizontally (such as if FIG. 2 were rotated ninety degrees), then, for example, display 201 may display the user interface in a landscape configuration. Likewise, one or more of buttons 202-207 may be associated with different actions depending upon the physical orientation of computer 200. For example, the actions shown in Table 1 may apply only to a horizontal orientation of computer 200, whereas a different association may apply responsive to computer 200 being rotated ninety degrees.

In addition to setting the button mapping, button injector API 306 may also allow software application 313 to read the button mapping. Such a query may include the button ID, the button event, and/or the orientation of the computing device, and the result of the query may be the action that is assigned to that particular combination of properties. Or, the entire mapping or an arbitrary subset of the mapping may be provided to software application 313 upon query via button injector API 306. Software application 313 may further query, via button injector API 306, how many buttons are known to exist on the computing device and/or how many of those buttons are mapped to an action.

Button injector API 306 also allows software application 313 to inject a specified button event. To inject a button event is to cause virtual button driver 311 to simulate the button event without the need for the actual hardware button to physically experience the button event. Button injector API 306 provides for software application 313 to specify one or more of buttons 202-207 and a button event associated with that button(s). In response, button injector API 306 communicates with virtual button driver 311 such that virtual button driver 311 simulates the actual button event and sends information to button event processing unit 302 letting it know that the button event has occurred. Button event processing unit 302 may not know the difference between a simulate button event from virtual button driver 311 and an actual button event communicated from HID button driver 304. In other words, the data from virtual button driver 311 and HID button drive 304 may be in the same format and, other than the source of the data, be otherwise indistinguishable.

Button injector API 306 has further sub-components: a data transformation sub-component 307, a mapping management sub-component 308, and a data management sub-component 309. Mapping management sub-component 308 is used for storing and retrieving associations between buttons 202-207 and the mapped actions in data repository 312. Data transformation and management sub-component 307 is used for receiving queries and commands from software application 313, and to transform the queries and commands into a different format that is usable by virtual button driver 311. Device management 309 handles any communication protocols necessary between button injector API 306 and virtual button driver 311.

The simulation of button events using the above-described architecture will now be discussed. Conventionally, when a button is pressed, held down, released, etc., a signal for that button 202-207 is sent to HID button driver 304, which in turn forwards data to button event processing unit 302. Button event processing unit 302 determines an appropriate action to take in response to the button event and forward data about that action and/or the button event to software application 301 (or to the operating system, as desired).

However, when simulating a button event, a different data path is taken. In this case, software application 313 is used for sending commands and/or queries using button injector API 306 in order to simulate the activation and/or deactivation of one or more of buttons 202-207, without the need for buttons 202-207 to actually be physically activated and deactivated. For example, referring to FIG. 5, a simplified illustrative process for simulating button events is shown. In step 401, software application 313 uses button injector API 306 to set a particular button mapping, as previously discussed. A mapping may be set for each of various physical orientations of computer 200.

Next, in step 402, software application 313 uses button injector API 306 to inject a specified button event for a specified one of buttons 202-207. In this regard, software application 313 may be programmed to cycle through a set of button events in a particular order. The data sent from button injector API 306 and/or from software application 313 representing a button injection may be in the form shown in FIGS. 5 and 6. This illustrative format assigns one bit for each of hardware buttons 202-207. In this example, there are thirty-two possible hardware buttons that may be referenced, even though computer 202 in this case has only six hardware buttons 202-207. So, hardware buttons 202-207 are each assigned a different bit, in this example bits zero through five, respectively. In FIG. 5, the data shown therein represents that a button event is to be simulate for button 207. In FIG. 6, the data shown therein represents that button events are to be simultaneously simulated for both buttons 203 and 205. The particular button events may also be specified separately. The shown format is merely illustrative; any data format may be used.

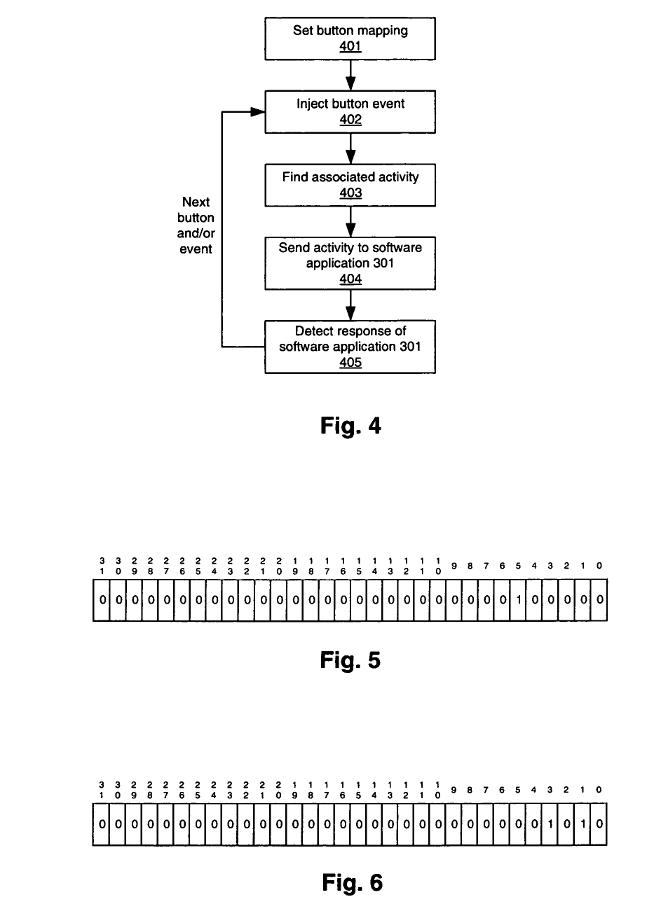

In response to a button injection request from software application 313, button injector API 306 sends data to virtual button driver 311, indicating the button ID of the specified button and the specified button event. In response, virtual button driver 311 converts the received data to further data that represents the button event and the button ID and sends this data to button event processing unit 302. In response, button event processing unit 302 checks data repository 312 in step 403 to determine which activity is mapped to the particular button and button event, as well as to the current orientation of computer 200 (if desired). If a mapping exists, then the associated activity is found and in step 404 button event processing unit 302 sends further data to software application 301, indicating the activity. In response, software application 301 performs some function based on the activity (e.g., paging up), and in step 405 software application 312 (or a separate monitoring software application) detects the response of software application 301 to determine whether the response is correct and expected. The process is continued for further buttons and/or button events on the same button, as desired. The flowchart of FIG. 4 is simplified, and variations are envisioned. For instance, the next button and/or button event chosen may depend upon the response of software application 301 as detected in step 405.

In this way, the functionality of software 301 may be determined relative to various button events associated with button 202-207. This may advantageously be accomplished without ever having to actually perform a button event on the actual hardware buttons 202-207, thus substantially speeding the testing process while also making it more reliable and flexible.

What is claimed is:

1. A computer-readable medium storing computer-executable components, comprising:
an interface component in a user mode for associating a plurality of hardware buttons of a computing device with a plurality of actions, for receiving first data identifying a first selected one of the hardware buttons and an associated button event, and for generating second data identifying the first selected hardware button and its associated button event; and
a first driver component in a kernel mode for receiving the second data and for generating third data identifying the first selected hardware button and its associated button event.

2. The computer-readable medium of claim 1, wherein the first driver component is a Human Interface Device (HID) driver.

3. The computer-readable medium of claim 1, wherein the interface component further includes sub-components, including:
a mapping management sub-component for storing and retrieving associations between the plurality of hardware buttons and the plurality of actions; and
a data transformation and management sub-component for receiving the first data and generating the second data, wherein the second data is different from the first data.

4. The computer-readable medium of claim 1, wherein the computer-executable components further include a second driver component in the kernel mode for receiving fourth data identifying a second selected one of the hardware buttons and an associated button event, and for generating fifth data identifying the second selected hardware button and its associated button event.

5. The computer-readable medium of claim 4, wherein the third data and the fifth data are in a same data format.

6. The computer-readable medium of claim 4, wherein the computer-executable components further include a button processing component in the user mode for receiving the third and fifth data, for generating sixth data identifying the action associated with the first selected hardware button, and for generating seventh data identifying the action associated with the second selected hardware button.

7. The computer-readable medium of claim 1, wherein the first data and the fourth data are in a different data format.

8. The computer-readable medium of claim 1, wherein the computer-executable components further include a button processing component in the user mode for receiving the third data and for generating sixth data identifying the action associated with the first selected hardware button.

9. The computer-readable medium of claim 1, wherein the button event associated with the first selected hardware button is one of a button press event and a button release event.

10. The computer-readable medium of claim 1, wherein the button event associated with the first selected hardware button is a combination of at least one button press event and at least one button release event.

12. The computer-readable medium of claim 1, wherein the interface component associates the plurality of hardware buttons with a plurality of actions in a manner that depends upon a physical orientation of the computing device.

13. A computer-assisted method, comprising steps of:
determining a first action;
selecting a hardware button from a plurality of hardware buttons and a button event, based on an association between the plurality of hardware buttons and button events and a plurality of actions including the first action;
generating first data in a user mode identifying the selected hardware button and the button event;
generating second data in a kernel mode identifying the selected hardware button and the button event; and
responsive to the second data, generating third data in the user mode identifying the action associated with the selected hardware button and the button event.

14. The method of claim 13, further including a step of defining and storing the association between the plurality of hardware buttons and button events and the plurality of actions.

15. The method of claim 13, wherein the step of generating the second data includes generating the second data in a Human Interface Device (HID) layer.

16. A computer-readable medium storing computer-executable instructions for performing the steps recited in claim 13.
